(19) United States
(12) Patent Application Publication
(10) Pub. No.: US 2005/0010341 A1
(43) Pub. Date: Jan. 13, 2005

(54) REMOTE DIAGNOSTICS DEVICE (RDU)

(75) Inventors: Joseph M. MacNamara, Ashland, OH (US); Gusztav Holler, Elyria, OH (US); Cem Hatipoglu, Rocky River, OH (US); William P. Amato, Avon, OH (US); Julie A. Miller, Lorain, OH (US); Jeffrey A. White, Sheffield Lake, OH (US); James P. Porter, Tallmadge, OH (US)

Correspondence Address: CALFEE HALTER & GRISWOLD, LLP, 800 SUPERIOR AVENUE, SUITE 1400, CLEVELAND, OH, 44114, US

(73) Assignee: BENDIX COMMERCIAL VEHICLE SYSTEMS LLC, Elyria, OH (US)

(21) Appl. No.: 10/605,239

(22) Filed: Sep. 17, 2003

Related U.S. Application Data
(60) Provisional application No. 60/412,595, filed on Sep. 20, 2002.

(51) Int. Cl. G06F 19/00

(52) U.S. Cl. 701/33; 701/29; 340/438

(57) ABSTRACT

A remote diagnostic unit for use with a heavy vehicle includes a pin connector communicating with a data bus on the vehicle. The pin connector receives a signal from the data bus. A microcontroller receives and interprets a standard diagnostic message as a function of the signal received by the pin connector. A plurality of lights are controlled by the microcontroller as a function of the standard diagnostic message.

### CROSS REFERENCE TO RELATED APPLICATIONS

This application claims the benefit of U.S. Provisional Application No. 60/412,595, filed Sep. 20, 2002.

### BACKGROUND OF INVENTION

The present invention relates to diagnostic units. It finds particular application in conjunction with diagnostic units used for vehicles and will be described with particular reference thereto. It will be appreciated, however, that the invention is also amenable to other applications.

Light emitting diodes (LEDs) on-board an electronic control unit (ECU) are used to indicate a finite number of faults on diagnostic units. Such diagnostic units are used for indicating faults in electronic systems (e.g., vehicle adaptive braking systems including an antilock braking system (ABS), transmission control systems, engine control systems, etc). An operator may reset and/or auto-configure the ECU (e.g., via a switch). In this sense, the LEDs are used as a first step in diagnosing a failure in an ABS. However, recent trends in locating ABS/automatic traction control (ATC) ECUs have tended to make on-board LEDs non-functional to the user in certain applications (e.g., where LEDs are hidden or difficult to see due to ECU location/orientation). In addition, although LEDs are not always used or desired by buyers, manufacturers tend to include on-board LEDs on all ECUs to accommodate the buyers that do utilize the LEDs. The cost of on-board LEDs introduces unnecessary burdens on ECU manufacturers and buyers in cases where LEDs are not used by the buyers.

For the reasons discussed above, ECUs that do not include diagnostic displays (e.g., on-board LEDs) are becoming more popular. Furthermore, for those customers who desire diagnostic information from the ECU, discrete diagnostic units have been developed to convey such information to a location remote from the ECU. For example, a diagnostic communication interface (DCI) unit has been disclosed in U.S. Pat. No. 6,114,952, (“the '952 patent”) which is hereby incorporated by reference.

The DCI unit disclosed in the '952 patent communicates with a data bus (e.g., a serial data bus having a J1587 vehicle diagnostic connector) via a cable. Furthermore, the DCI includes a plurality of LEDs for communicating diagnostic information from the ECU to an operator. However, when used by itself, the DCI of the '952 patent is only capable of interpreting proprietary messages received from the data bus. In order to interpret standard messages received from the ECU over the data bus, the DCI of the “952 patent must communicate with an external processor (e.g., a PC) via a port connector.

The present invention provides a new and improved apparatus and method which addresses the above-referenced problems.

### SUMMARY OF INVENTION

In one embodiment, a remote diagnostic unit for use with a heavy vehicle includes a pin connector communicating with a data bus on the vehicle. The pin connector receives a signal from the data bus. A microcontroller receives and interprets a standard diagnostic message as a function of the signal received by the pin connector. A plurality of lights are controlled by the microcontroller as a function of the standard diagnostic message.

In one aspect, the microcontroller includes a UART.

In another aspect, a reset switch communicates with the microcontroller for at least one of clearing the diagnostic message from the microcontroller and resetting an ECU communicating with the data bus.

In another aspect, the diagnostic message indicates a status of an ABS ECU on the vehicle.

In another aspect, the data bus is a J1587 serial data bus. A plurality of the pin connectors communicate with the J1587 serial data bus.

In another aspect, a signal conditioner between the pin connector and the microcontroller conditions the signal received by the pin connector into the standard diagnostic message, which is interpreted by the microcontroller.

In another aspect, the signal conditioner is an RS485 device.

In another aspect, the microcontroller is a PIC16F870 device.

In another aspect, the lights include light emitting diodes.

In another embodiment, a remote diagnostic communication interface for use with a heavy vehicle includes a pin connector communicating with a data bus on the vehicle. The pin connector receives a signal from the data bus. The signal is conditioned for producing a standard diagnostic message as a function of the signal. The diagnostic message is interpreted. A plurality of lights are selectively illuminated as a function of the standard diagnostic message.

In another embodiment, a system for diagnosing an electrical system on a heavy vehicle includes an electronic control unit. A data bus communicates with the electronic control unit. A remote diagnostic unit includes a pin connector. A microcontroller receives and interprets a standard diagnostic message as a function of the signal received by the pin connector. A plurality of lights are controlled by the microcontroller as a function of the standard diagnostic message.

In another embodiment, a method for remotely displaying a fault status of an electronic control unit includes determining the fault status of the electronic control unit. A signal is transmitted from the electronic control unit to the data bus. The signal indicates a standard message for identifying a fault status of the electronic control unit. The signal is received into a remote diagnostic unit. The signal is interpreted as the standard message within the remote diagnostic unit. Selected lights are illuminated on the remote diagnostic unit as a function of the standard message.

### BRIEF DESCRIPTION OF DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a diagrammatic illustration of a vehicle antilock diagnostic system using a remote diagnostic unit in accordance with one embodiment of the present invention;

FIG. 2 illustrates a perspective view of a front of the remote diagnostic unit in accordance with one embodiment of the present invention;

FIG. 3 illustrates a perspective view of a back of the remote diagnostic unit in accordance with one embodiment of the present invention;

FIG. 4 illustrates a perspective view of a vehicle connector in accordance with one embodiment of the present invention;

FIG. 5 illustrates a block diagram showing the functional relationship of the remote diagnostic components in accordance with one embodiment of the present invention; and

FIG. 6 illustrates a detailed electrical schematic of the remote diagnostic unit in accordance with one embodiment of the present invention.

### DETAILED DESCRIPTION

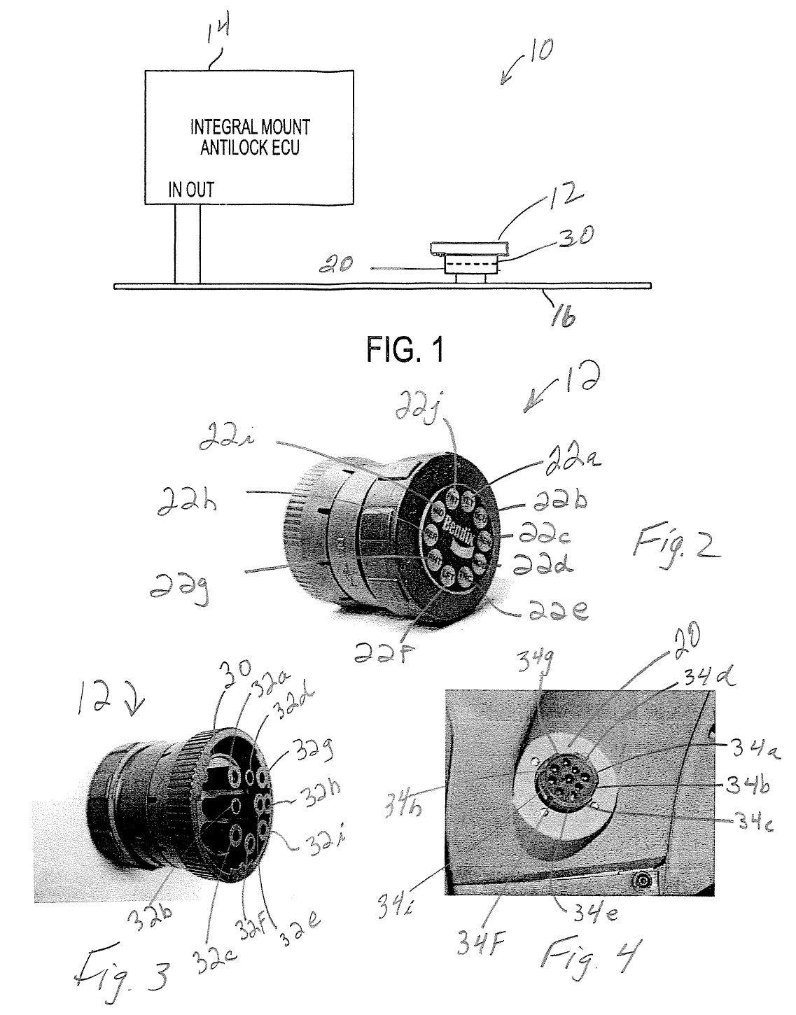

With reference to FIG. 1, a vehicle antilock diagnostic system 10 includes a remote diagnostic unit (RDU) 12. An antilock electronic control unit (ECU) 14 is integrally mounted to a vehicle chassis including an associated antilock brake system (ABS)/automatic traction control (ATC) unit. In one embodiment, the vehicle is a heavy vehicle (e.g., a truck or bus); however, other types of vehicles are also contemplated. The ECU 14 communicates with the RDU 12 along a communication bus 16 (data bus) on the vehicle. In one embodiment, the communication bus 16 is a serial data bus having a J1587 vehicle diagnostic connector 20 to which the RDU 12 is connected.

The RDU 12 includes a plurality of lights 22a, 22b, 22c, 22d, 22e, 22f, 22g, 22h, 22i, 22j (e.g., ten (10)) (see FIG. 2), which provide a diagnostic check (e.g., a fault status) of the ABS/ATC and an indication that the RDU 12 has a power source and that a communications link is established between the RDU 12 and the EDU 14 via the bus 16. In one embodiment, the lights 22 are light emitting diodes (LEDs).

The ECU 14, which comprises a part of the larger electronic diagnostic system 10 is housed within an enclosure which is mounted on the vehicle chassis. The ECU 14 further includes ports for connection to vehicle speed sensors and adaptive braking pressure modulators. The speed sensors are normally wheel speed sensors mounted at the vehicle wheels. Such sensors are conventional and provide a pulsed output which is transmitted to the ECU 14, the frequency of the pulses being proportional to wheel velocity. The ECU 14 generates output signals which control one or more brake pressure modulators. The brake pressure modulators are known in the art and are also conventional. The brake pressure modulators are adapted to decrease and thereafter increase braking pressure in response to impending wheel lockup conditions detected by the ECU 14 as a function of the signals generated by the speed sensors.

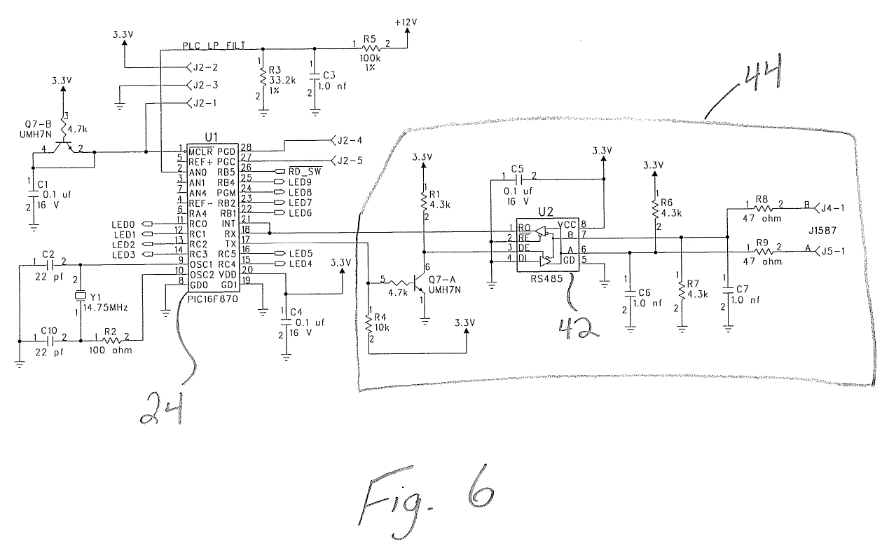

The ECU 14 also includes diagnostics which check the ECU 14, the modulators, wheel speed sensors, system voltage and for faults. The ECU 14 logs these faults and broadcasts the fault status to the RDU 12 via the bus 16. In response to such faults, a microcontroller 24 (see FIG. 5) on the RDU 12 activates one or more of the LEDs, which are provided on the RDU 12 to indicate faults in the speed sensors, the modulators, or the ECU microprocessor 14. Therefore, the lights are controlled as a function of the microcontroller and the standard message.

One or more discrete LEDs is provided for each of the possible faults detected, so that the mechanic servicing the vehicle can immediately tell, by examining the status of the LEDs on the RDU 12 which of the components of the system is malfunctioning. Since many of the malfunctions sensed by the aforementioned diagnostics are of a transient or temporary nature, and which are eliminated when the system powers down upon vehicle shutoff, a nonvolatile random access memory in the ECU 12 is provided to store the faults detected by the aforementioned diagnostics. Therefore, upon powerup when the vehicle is started the same LEDs are again activated as were activated immediately before shutdown and are transmitted to the RDU 12. A fault reset switch 26 (see FIG. 5) on the RDU 12 is used for clearing (resetting) the ECU 14 (and the light emitting diodes) when the vehicle has been serviced and the faults no longer exist. It is also contemplated that the fault reset switch 26 be used for causing the ECU 14 to cycle through a self-configuration mode.

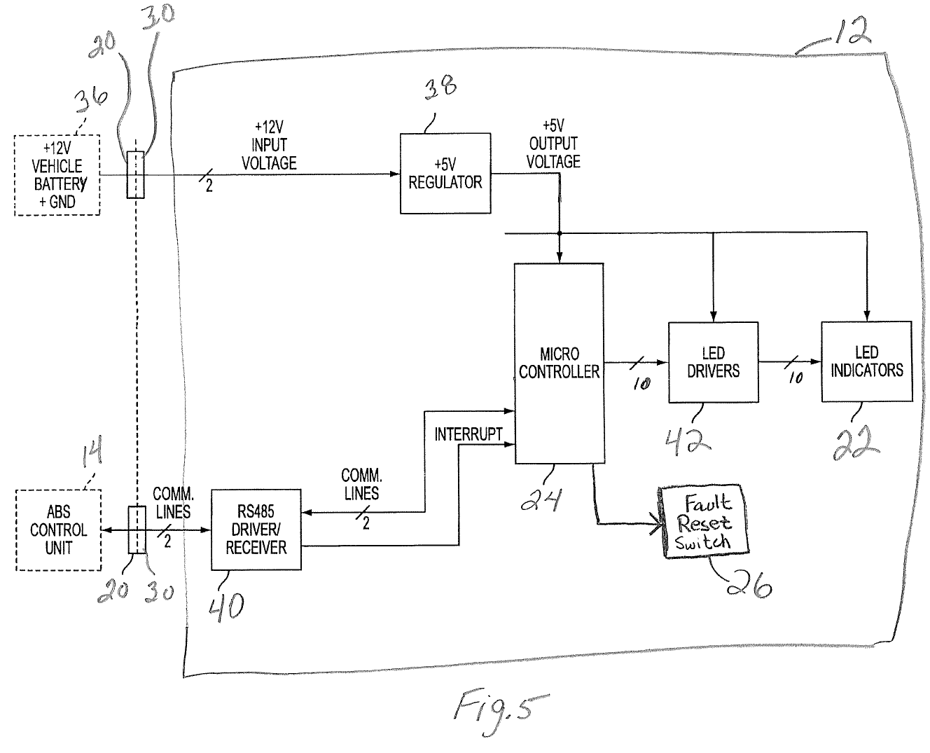

With reference to FIGS. 2 and 3, the RDU 12 is an electronic, diagnostic tool for locating ABS/ATC faults. The RDU 12 includes the ten LEDs 22 and the fault reset switch 26 (see FIG. 5). The LEDs 22 are used for indicating that the RDU 12 is receiving power, that a communication link is established between the RDU 12 and the ECU 14, a position of a suspected issue in the ABS/ATC, and a suspected issue with a suspected component or its wiring. In one embodiment, the fault reset switch 26 is a magnetic reset switch that is responsive to a magnet being passed within a certain distance of the RDU 12.

The RDU 12 is designed to be used as a stand-alone discrete unit for interpreting signals (messages) received from the bus 16. In one embodiment, the signals transmitted from the ECU 14 are formatted according to a standard messaging protocol for the J1587 serial data bus (“standard messages”). The RDU 12 is capable of receiving and interpreting the standard messages. Because the RDU 12 is capable of interpreting messages formatted according to the standard messaging protocol, the RDU 12 is capable of receiving and interpreting messages from ABS/ATC ECUs manufactured by a variety of manufacturers as long as the ECU produces standard messages. Alternatively, it is contemplated in another embodiment that the RDU 12 is also capable of receiving and interpreting messages formatted according to a proprietary protocol.

With reference to FIGS. 3 and 4, the RDU 12 communicates with the bus 16 (see FIG. 1) via an RDU connector 30 including nine (9) pin connectors 32a, 32b, 32c, 32d, 32e, 32f, 32g, 32h, 32i. The vehicle connector 20 (e.g., a J1587 diagnostic link connector), which is typically located in the driver's compartment of the vehicle, includes nine (9) pin connectors 32a, 32b, 32c, 32d, 32e, 32f, 32g, 32h, 32i that are designed to mate with the nine (9) pin connectors 32 of the RDU connector 30. Although the illustrated embodiment includes nine (9) pins in the RDU connector 30 and the vehicle connector 20, other embodiments including, for example, six (6) pin connectors are also contemplated.

With reference to FIG. 5, power for the RDU 12 is supplied by a battery 36 (e.g., the vehicle battery), which supplies a +12 volt power including a ground to a +3.3 volt voltage regulator 38. The voltage regulator 38 provides a constant, smooth +3.3 volt output for the various components of the RDU 12. The RDU connector 30 and the vehicle connector 20 connect the battery 36 to the voltage regulator 38 in the RDU 12. Similarly, the RDU connector 30 and the vehicle connector 20 connect the RDU 12 to the ECU 14.

Signals received in the RDU 12 from the ECU 14 are communicated to a driver/receiver 40 (conditioning means). The driver/receiver 40 receives the signals, which represent messages from the ECU 14, and conditions the signals to be understood and processed by the microcontroller 24. In other words, the driver/receiver 40 conditions the signals into signals (e.g., standard or proprietary messages) that can be understood and processed by the microcontroller 24. Therefore, the signals (messages) received by the microcontroller 24 are generated by the driver/receiver 40 as a function of the signals transmitted from the ECU 14.

The driver/receiver 40 also conditions information signals transmitted from the microcontroller 24, which are transmitted as messages to the ECU 14 via the bus 16. The driver/receiver 40 generates and sends an interrupt signal to the microcontroller 14 when the ECU attempts to send a message to the microcontroller 24. The microcontroller 24 reacts to the interrupt signal and reads the information from the driver/receiver 40. As discussed above, the information is transmitted between the ECU 14 and the RDU 12 via the bus 16, the RDU connector 30, and the vehicle connector 20. The signal header identifies the message to the microcontroller as an ABS diagnostic communication. If the message identifies an ABS fault, the microcontroller 24 activates various one(s) of the LEDs 22 through an LED driver circuit 42.

The fault reset switch 26 is used to manually send a clear (reset) message to the ECU 14 when an ABS fault is corrected. Similarly, the fault reset switch 26 is used for sending a self-configuration command to the ECU 14 if, for example, the ECU 14 is configured incorrectly. In one embodiment, the reset switch 26 is sealed within the RDU 12 and is magnetically responsive. More specifically, the reset switch 26 is activated by placing a magnet within a range causing a magnetic response in the magnetic reset switch 26. An activation of the magnetic response switch 26 for a first predetermined time, for example, greater than one (1) second but less than about twenty (20) seconds clears (resets) the current fault in the ECU 14 using a reset command. Therefore, all of the LEDs 22 turn-off. A longer activation of the magnetic reset switch 26 (e.g., if the magnet is held within the range for activating the switch for a second predetermined time, for example, greater than about twenty (20) seconds but less than about sixty (60) seconds) causes the self-configuration command to be transmitted to the ECU 14. The self-configuration command causes the ECU 14 to enter a reconfiguration mode. In this embodiment, no action is performed if the magnetic reset switch 26 is activated for longer than about sixty (60) seconds. Furthermore, it is contemplated in this embodiment that the reset command is a standard command and the self-configuration command is a proprietary command; however, other embodiments, in which any command is either a standard command or proprietary command and is transmitted as a function of the fault reset switch 26, are also contemplated.

With reference to FIG. 6, a detailed electrical schematic including the microcontroller 24 and a conditioning circuit 44 in one embodiment of the present invention is illustrated. In this embodiment, the microcontroller 24 is a device including a universal asynchronous receiver-transmitter (UART) (e.g., a PIC16F870 device); also, the conditioning circuit 44 includes the driver/receiver 40, which is illustrated as an RS485 device. Although the microcontroller 24 is illustrated as a PIC16F870, it is to be understood that other embodiments, including other devices having a UART for transforming the signals transmitted from the ECU into the standard messages that can be interpreted by the microcontroller 24 are also contemplated. Similarly, it is to be understood that other embodiments, including other driver/receiver circuits having other devices, are also contemplated.

Although the present invention has been described with reference to an ABS ECU, it is to be understood that other embodiments in which the remote diagnostic unit indicates a fault status of other ECUs on the vehicle (e.g., a transmission ECU, an engine ECU, etc.) are also contemplated.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A remote diagnostic unit for use with a heavy vehicle, comprising:
a pin connector communicating with a data bus on the vehicle, the pin connector receiving a signal from the data bus;
a microcontroller receiving and interpreting a standard diagnostic message as a function of the signal received by the pin connector; and
a plurality of lights controlled by the microcontroller as a function of the standard diagnostic message.

2. The remote diagnostic unit as set forth in claim 1, wherein the microcontroller includes a UART.

3. The remote diagnostic unit as set forth in claim 1, further including:
a reset switch, communicating with the microcontroller, for at least one of clearing the diagnostic message from an ECU and causing the ECU to enter a self-configuration mode.

4. The remote diagnostic unit as set forth in claim 1, wherein the diagnostic message indicates a status of an ABS ECU on the vehicle.

5. The remote diagnostic unit as set forth in claim 1, wherein the data bus is a J1587 serial data bus, further including:
a plurality of the pin connectors for communicating with the J1587 serial data bus.

6. The remote diagnostic unit as set forth in claim 1, further including:
a signal conditioner, between the pin connector and the microcontroller, for conditioning the signal received by the pin connector into the standard diagnostic message, which is interpreted by the microcontroller.

7. The remote diagnostic unit as set forth in claim 6, wherein the signal conditioner is an RS485 device.

8. The remote diagnostic unit as set forth in claim 1, wherein the microcontroller is a PIC16F870 device.

9. The remote diagnostic unit as set forth in claim 1, wherein the lights include light emitting diodes.

10. A remote diagnostic communication interface for use with a heavy vehicle, comprising:
a pin connector communicating with a data bus on the vehicle, the pin connector receiving a signal from the data bus;
means for conditioning the signal and producing a standard diagnostic message as a function of the signal;
means for receiving and interpreting the standard diagnostic message; and
a plurality of lights being selectively illuminated as a function of the standard diagnostic message.

11. The remote diagnostic communication interface as set forth in claim 10, wherein the means for conditioning includes an RS485 device.

12. The remote diagnostic communication interface as set forth in claim 10, wherein the means for receiving and interpreting the standard diagnostic message includes a UART.

13. The remote diagnostic communication interface as set forth in claim 12, wherein the means for receiving and interpreting the standard diagnostic message includes a PIC16F870 device.

14. The remote diagnostic communication interface as set forth in claim 10, wherein the pin connector communicates with the data bus via a vehicle connector.

15. The remote diagnostic communication interface as set forth in claim 10, further including:
a reset switch, communicating with the means for receiving and interpreting the standard diagnostic message, for at least one of selectively clearing an ECU and selectively causing the ECU to enter a reconfiguration mode.

16. The remote diagnostic communication interface as set forth in claim 15, wherein:
the reset switch is activated in response to a magnet;
the ECU is cleared when the reset switch is activated for a first period of time; and
the ECU enters the reconfiguration mode when the reset switch is activated for a second period of time.

17. The remote diagnostic communication interface as set forth in claim 10, wherein:
the lights are light emitting diodes; and
the standard diagnostic message indicates a fault status of an associated ECU.

18. A system for diagnosing an electrical system on a heavy vehicle, the system including:
an electronic control unit;
a data bus communicating with the electronic control unit; and
a remote diagnostic unit, including:
a pin connector;
a microcontroller receiving and interpreting a standard diagnostic message as a function of the signal received by the pin connector; and
a plurality of lights controlled by the microcontroller as a function of the standard diagnostic message.

19. The system for diagnosing an electrical system as set forth in claim 18, further including:
a reset switch, communicating with the microcontroller, for one of clearing the diagnostic message from an ECU and transmitting a self-configuration command to the ECU.

20. The system for diagnosing an electrical system as set forth in claim 18, wherein the data bus is a J1587 serial data bus.

21. The system for diagnosing an electrical system as set forth in claim 18, further including:
a vehicle pin connector, communicating with the data bus, which mates with the pin connector of the remote diagnostic unit.

22. The system for diagnosing an electrical system as set forth in claim 18, wherein the standard diagnostic message indicates a fault status of the electronic control unit.

23. The system for diagnosing an electrical system as set forth in claim 18, wherein the microcontroller includes a UART.

24. The system for diagnosing an electrical system as set forth in claim 18, wherein the data bus is a J1587 serial data bus.

25. A method for remotely displaying a fault status of an electronic control unit, the method comprising:
determining the fault status of the electronic control unit;
transmitting a signal from the electronic control unit to the data bus, the signal indicating a standard message for identifying a fault status of the electronic control unit;
receiving the signal into a remote diagnostic unit;
interpreting the signal as the standard message within the remote diagnostic unit; and
illuminating selected lights on the remote diagnostic unit as a function of the standard message.

26. The method for remotely displaying a fault status as set forth in claim 25, wherein the interpreting includes:
conditioning the signal into the standard message; and
identifying the fault status as a function of the standard message.

27. The method for remotely displaying a fault status as set forth in claim 26, wherein:
the conditioning includes:
transforming the signal into the standard message in a circuit including an RS485; and
the identifying includes:
identifying the fault status within a UART included within a microcontroller of the remote diagnostic unit.

28. The method for remotely displaying a fault status as set forth in claim 25, further including:
activating a reset switch for at least one of clearing the electronic control unit and causing the electronic control unit to enter a reconfiguration mode.

29. The method for remotely displaying a fault status as set forth in claim 28, wherein the reset switch is a magnetic switch, the activating including:
passing a magnet within a range for causing a response in the magnetic switch.
